(19) United States
(12) Patent Application Publication
(10) Pub. No.: US 2008/0096523 A1
(43) Pub. Date: Apr. 24, 2008

(54) An Arrangement, a Node and a Method Relating to Handling of Lost/Discarded Data Packets

(76) Inventors: Niklas Lundin, Torslanda (SE); Anders P. Larsson, Molndal (SE)

Correspondence Address: ERICSSON INC., 6300 LEGACY DRIVE, M/S EVR 1-C-11, PLANO, TX, 75024, US

(21) Appl. No.: 10/595,057

(22) PCT Filed: Jul. 22, 2003
(86) PCT No.: PCT/EP03/07995

§ 371 Date: Apr. 9, 2007

(51) Int. Cl. H04L 12/14; H04M 15/00

(52) U.S. Cl. 455/406; 705/34

(57) ABSTRACT

The present invention relates to an arrangement, for allowing compensation of lost, discarded or unsent traffic on the downlink in a communication system supporting communication of packet data and classification of mobile traffic allowing application of different charging schemes for different types of traffic. It comprises a packet data node (PDN, G-PDN; GGSN; SGSN, CGSN) handling classification of traffic into different types, e.g. service class, and for applying an appropriate charging scheme depending on type. Said node provides (labels) and sends information relating to at least type, e.g. service class, to subsequent nodes (PDN, SGSN; RNC; BSC) on the downlink to a mobile station and a subsequent node (PDN; SGSN; RNC; BSC) detecting a packet loss, notes said loss and enables use of the information of the said loss together with at least type information to enable for correction of charging due to traffic loss.

### FIELD OF THE INVENTION

The present invention relates to an arrangement for allowing compensation or correction in relation to lost or unsent data packets on the downlink in a communications system supporting communication of packet data and classification of mobile data packet traffic in order to allow content based or flexible charging for different types of traffic.

The invention also relates to a packet data node allowing compensation or correction as referred to above. Still further the invention relates to a method for allowing charging correction or compensation for lost or unsent data packets on the downlink in a communications system supporting communication of packet data and content based or flexible charging depending on traffic type.

### STATE OF THE ART

Charging associated with communication with a mobile station is a problematic issue. Operators at an early stage realized that it is risky to base charging on volume as well as on time since it is difficult to establish how much of the desired/intended traffic that actually reaches the subscriber, or if it is lost or discarded on its way on the downlink towards the mobile station, and further since packets may be resent several times. It is known to divide or classify different types of traffic e.g. into different service classes (QoS) among others depending on how urgent traffic is, how important it is that all packets arrive etc. Furthermore it is known to implement different charging schemes for different types of traffic, e.g. a content based functionality or a flexible (bearer) charging functionality. It is known to implement such a functionality on a gateway packet data node, e.g. GGSN (Gateway GPRS Support Node), which then performs a classification of mobile traffic. This classification is then used to apply different charging schemes to different types of traffic. However, on the downlink, on its way to a mobile station, data traffic may be lost or discarded. Examples thereon are e.g. when traffic is thrown or discarded due to the fact that it has a lower priority when e.g. radio resources are scarce. In GSM/GPRS (UMTS) data traffic can be lost or discarded in e.g. the nodes SGSN (Serving GPRS Support Node) or in BSC (Base Station Controller). In e.g. WCDMA data traffic may be lost in SGSN or RNC (Radio Network Controller).

There is still no satisfactory and complete solution for the handling of lost traffical packets on the downlink for charging purposes if a flexible or content based charging functionality is implemented. The GGSN (for example) charges (differently) for different types of traffic (applications), and sometimes a part of the traffic that the subscriber is charged for actually never reached the subscriber. This is a serious problem, not only for the subscriber, who has to pay for information he did not receive, but also for the operator since it severely may reduce and affect customer's confidence in the operator, and the offered services.

A node comprising the above discussed flexible charging functionality classifies the traffic and applies the appropriate charging scheme. However, later on their path towards the subscriber, downlinks, packet losses may occur. The amounts of packets that are lost could be counted in SGSN, but it is not possible for SGSN to acquire information as to which type or class lost packets belonged to. Even more, it is not possible for GGSN (i.e. the node handling classification and flexible charging) to acquire such information.

### SUMMARY OF THE INVENTION

What is needed is therefore an arrangement that allows for more accurate charging, i.e. an arrangement through which a user can be charged for the packets that actually do arrive to the user. It is also needed an arrangement implementing flexible or content depending charging through which losses of packets can be taken into account, irrespectively of where on the downlink such losses occur, particularly in an SGSN, a BSC and/or an RNC.

Still further an arrangement is needed through which more accurate charging can be provided, if real time based charging is implemented or if CDR (Charging Data Record) based charging is implemented, i.e. non-real-time based charging.

Further yet an arrangement is needed which is easy and cheap to install and implement, and the operation of which is secure.

A node for implementing such a functionality in operative cooperation with subsequent nodes downlinks is also needed through which one or more of the above mentioned objects can be achieved. A method for fulfilling one or more of the above mentioned objects is also needed.

Therefore an arrangement as initially referred to and having the characterizing features of claim 1 is provided.

A node having the characterizing features of claim 22 is therefore also provided.

Therefore also a method as initially referred to is provided which has the characterizing features of claim 26. Advantageous and preferred or alternative embodiments are given by the appended subclaims.

### BRIEF DESCRIPTION OF THE DRAWINGS

The invention will in the following be further described in a non-limiting manner, and with reference to the accompanying drawings, in which:

FIG. 1 is a very schematically block diagram illustrating an arrangement in an implementation to a GSM/GPRS system wherein flexible charging is implemented in GGSN,

FIG. 2 is a very schematical block diagram similar to FIG. 1 illustrating an implementation to a UMTS/GPRS system wherein flexible charging is implemented in GGSN,

FIG. 3 is a very schematical block diagram similar to FIG. 1 and FIG. 2 for a dual access node (SGSN) and wherein flexible charging is implemented,

FIG. 4 is a block diagram illustrating an implementation in which flexible charging is implemented in SGSN,

FIG. 5 is a block diagram illustrating a combined gateway and serving packet data node (CGSN) supporting flexible charging,

FIG. 6 is a signalling diagram for an arrangement as in FIG. 1, for one particular implementation,

FIG. 7 is a signalling diagram for an arrangement as in FIG. 2 for one specific implementation,

FIG. 8 is a signalling diagram for a dual access SGSN node according to another implementation,

FIG. 9 is a flow diagram describing the procedure according to an implementation in which GGSN supports flexible/content based charging,

FIG. 10 is a flow diagram describing the procedure where SGSN supports a flexible, content based charging functionality,

FIG. 11 is a flow diagram illustrating an embodiment wherein reports are included in Charging Data records,

FIG. 12 is a flow diagram illustrating an embodiment in which real time correction/compensation is allowed,

FIG. 13 shows the signal format and introduction of info between an access node and an RNC, and

FIG. 14 shows the signal format and introduction of information between an access node and BSC.

### DETAILED DESCRIPTION OF THE INVENTION

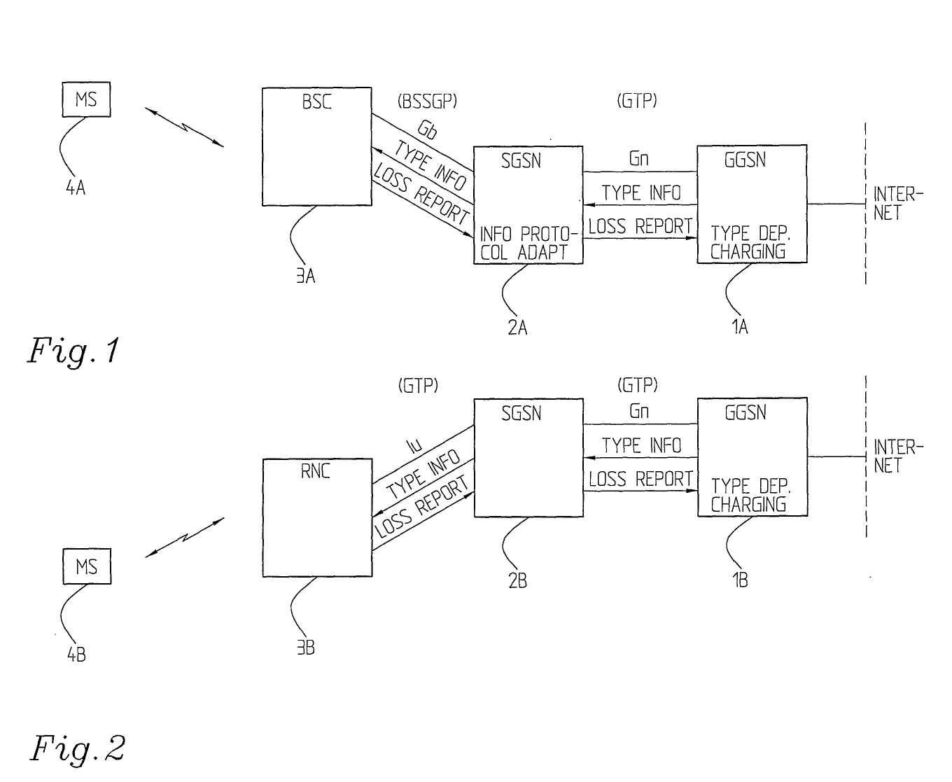

In the embodiment illustrated in FIG. 1 it is supposed that, in a GSM/GPRS system, GGSN 1A supports a type dependent charging functionality, i.e. charging depends on type of traffic, or service class belonging of the traffic (e.g. IP flow based bearer level charging). GGSN 1A communicates with SGSN 2A over the Gn-interface using the GTP (GPRS Tunneling Protocol) as is known per se, cf. 3GPP TS 29.060, which herewith is incorporated herein by reference. GGSN 1A here adds traffic type information (identified as a part of a type dependent charging functionality including classification of traffic, or separately obtaining type/classification information) to the GTP header of the downlink (DL) payload. The type information may be of different kinds, it may e.g. contain service class information, e.g. a service class tag. In addition thereto it may contain cost or rating information. It may also, in an advantageous implementation, contain chain id, which is used to identify the chain an IP packet belongs to when IP packets sharing the same service class cannot be identified until the key-IP packet for the particular chain has arrived at GGSN, or until a required number of packets have arrived. If this information is not included, it should be noted that loss of such a packet cannot be compensated for, but in some cases this might be acceptable.

SGSN 2A provides for the type information (at least) being sent also to BSC 3A (in this case). Only one BSC is shown in the figure for reasons of clarity. As is known the G_{b} interface is used between BSC and SGSN and BSSGP is used as communication protocol. BSSGP, Base Station System GPRS Protocol is described in 3GPP TS 48.018, which herewith is incorporated herein by reference. Since different protocols are used between GGSN and SGSN and SGSN and BSC respectively, the type info cannot simply be forwarded by SGSN to BSC, but instead a new information element with at least the type information may be added to the BSSGP DL-UNITDATA PDU (Packet Data Unit). MS 4A is shown merely for illustrative purposes in the figure.

Traffic can be discarded either by SGSN 2A or by BSC 3A. In case SGSN 2A discards traffic, the type information (at least) of the the discarded payload is added to the CDR (in a new field thereof). A loss report is sent to GGSN 1A if real-time compensation is implemented. In this embodiment it is not limited to sending of loss reports in any specific manner. It can be done based on time, volume, CDR:s may be used in a conventional manner by the operator to provide for compensation on a more or less regular basis, e.g. at night, when CDR:s are checked in any case. This will be further discussed below.

If instead it is BSC 3A that discards traffic this is reported in a loss report to SGSN 2A. This is illustrated in the figure but it may just as well be SGSN that discards traffic; SGSN has to report it to GGSN irrespectively if it being SGSN itself or BSC that has discarded traffic if real-time compensation is supported. In this embodiment BSC 3A notes the type information (e.g. at least service class tag) in the BSSGP header and includes it as a new information element in the BSSGP header, as a new information element in BSSGP LLC (Logical Link Control) Discarded message towards SGSN 2A. (Real time compensation may be supported or not as discussed above).

When a loss report from BSC 3A, i.e. a report of discarded traffic, is received in SGSN 2A, this information is included in the appropriate CDR in a new field by SGSN 2A. The CDR can then be post-processed together with the data of the type dependent charging functionality provided by the GGSN 1A to allow for a charging in which compensation is provided for lost traffic.

If real time compensation should be supported, a new GTP message, e.g. GTP Discarded traffic report has to be sent to the GGSN 1A (both if SGSN or BSC discarded the traffic) containing the information of the loss report together with IMSI and NSAPI (Network layer Service Access Point Identifier). If real time compensation is implemented, it is not, for the functioning of the inventive concept, necessary to include the loss report information in a CDR, but it may be advantageous to do so in order to keep the information that might be useful.

FIG. 2 is a Fig similar to FIG. 1 but with the difference that SGSN 2B supports communication with RNC 3B (UMTS). Also here it is supposed that GGSN 1B supports a type dependent charging functionality. MS 4B is merely shown for reasons of completeness. The interface used between SGSN 2B and RNC 3B is Iu as is known per se. However, in this case the GTP protocol is used also between SGSN 2B and RNC 3B, which makes it easier. The type information may then simply be forwarded from SGSN 2B as e.g. the same service tag to the RNC 3B. If RNC 3B discards traffic, it notes the type info, e.g. at least service tag as discussed with reference to FIG. 1, and sends this information as a new information element in RANAP Data Volume Report to SGSN 2B. (For non-real time compensation the message may be sent either when a RAB (Radio Access Bearer) is lost, or when PDP context is deactivated, whereas for real-time implementations the report should be sent immediately when traffic is discarded.)

RANAP, Radio Access Network Application Part, is discussed in 3GPP TS 25.413, which herewith is incorporated herein by reference.

When a loss report (Data Volume Report) is received in SGSN, this info may be included in the correct CDR in a new field as discussed with reference to FIG. 1.

It should be noted that for non-real time embodiments, the loss report does not have to be sent to GGSN, whereas for real time compensation embodiments the report has to be provided to GGSN (with IMSI and NSAPI (or correspondingly) as discussed above).

Generally the invention suggests a mechanism that makes it possible for an SGSN to identify which traffic class and cost/rating information discarded traffic had been allocated by a GGSN.

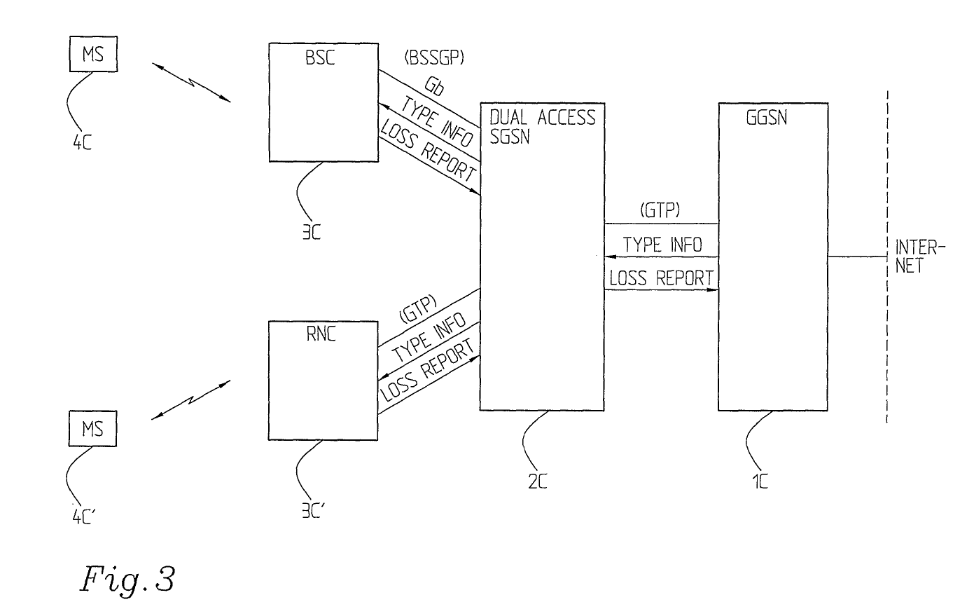

FIG. 3 is an embodiment in which the SGSN 2C (in communication with GGSN 1C) comprises a Dual Access Node supporting communication with BSC 3C as well as with RNC 3C′. MS 4C, 4C′ are illustrated for reasons of completeness.

The functioning is the same as that described above with reference to FIGS. 1 and 2, real time handling being supported or not, loss reports to GGSN 1C only being relevant for real time charging cases, whereas if CDR based charging is implemented, this is not necessary.

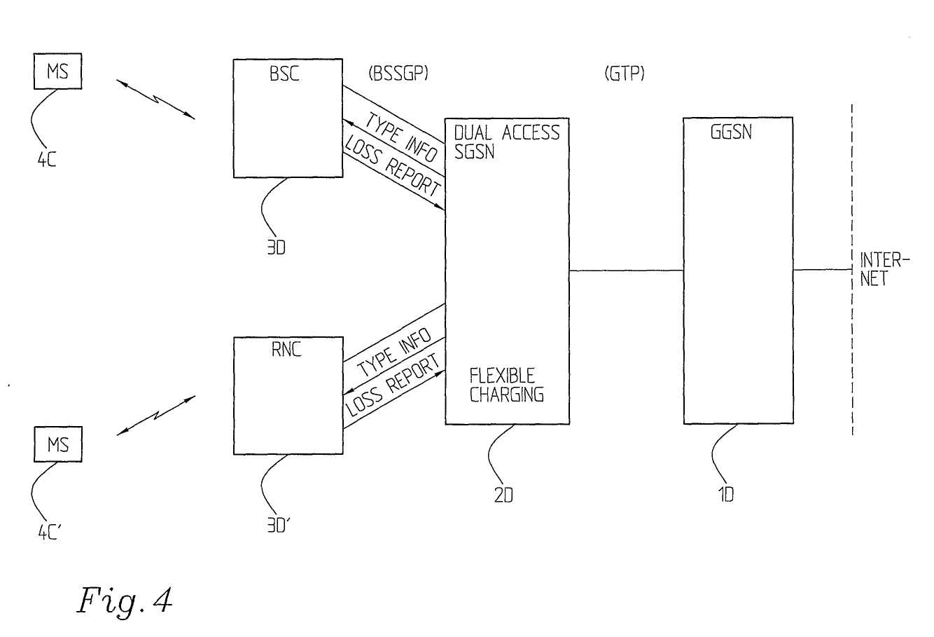

FIG. 4 shows an alternative implementation in which the type dependent, or flexible, charging functionality is provided in SGSN 2D instead of in GGSN 1D. It is here supposed that SGSN 2D is a dual access node supporting communication with BSC 3D as well as RNC 3D′. However, the inventive concept of course also covers the case when SGSN 2D only supports BSC 3D or RNC 3D′. The functioning is the same as that described with reference to FIGS. 1-3 with the difference that sending of type info (e.g. service class tag and possibly cost/rating info and/or chain id) between GGSN 1D and SGSN 2D is not necessary, neither to send any loss reports to GGSN.

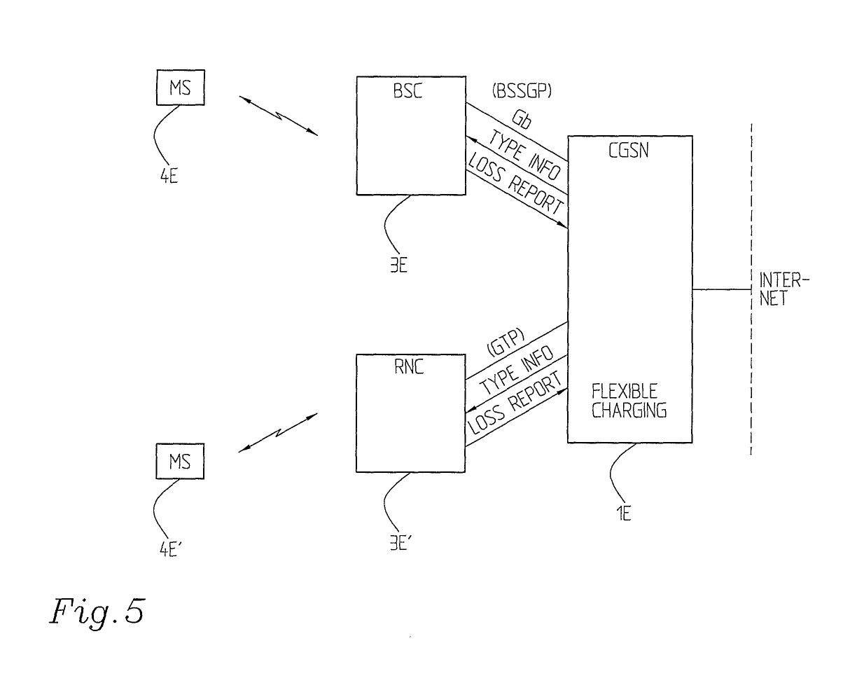

FIG. 5 shows still another implementation wherein a CGSN 1E is implemented which comprises the functionality of both a GGSN and a SGSN. CGSN 1E may support a dual access functionality or not i.e. support both or either of BSC 3E, RNC 3E′. The functioning is the same as that described in the foregoing, with the difference that no communication with a separate GGSN is needed, which thus makes the procedure even more straightforward.

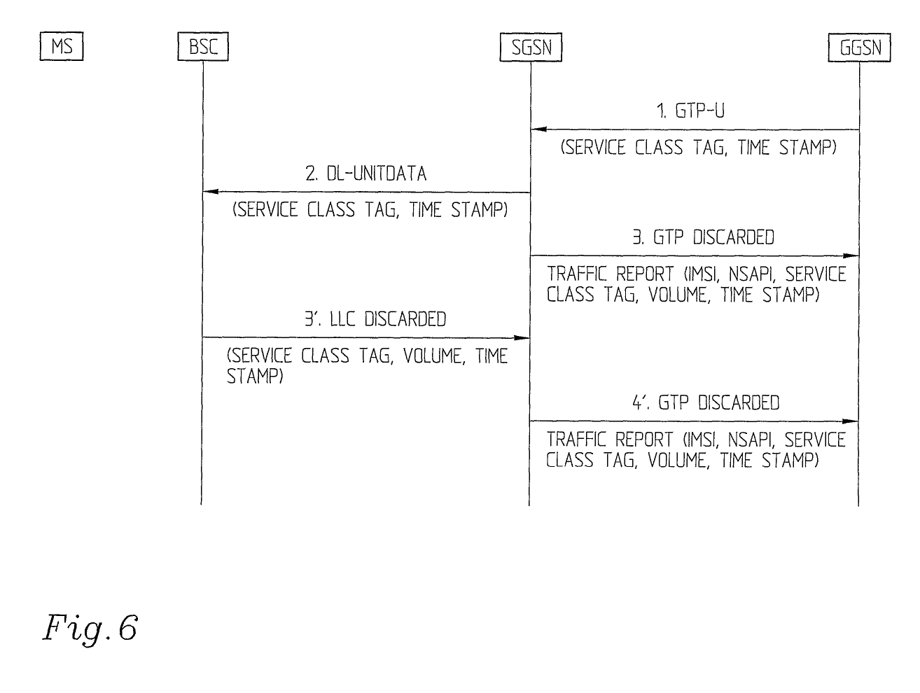

FIG. 6 is a signalling diagram illustrating the inventive procedure for an embodiment in which flexible/content based charging is supported in GGSN, in which SGSN supports communication with BSC:s and in which it is allowed for real time compensation of lost traffic.

It is here supposed that GGSN adds service class tag and a time stamp to the GTP header of the DL payload, 1. A time stamp is here used as an alternative to sending cost/rating info, which instead is identified in GGSN when a discarded traffic report with time stamp is received in GGSN. Chain id may be included or not. SGSN adds a new information element to BSSGP DL-UNITDATA, 2, and sends the service class tag info and time stamp on to BSC.

If SGSN discards traffic, a GTP Discarded traffic report with IMSI, NSAPI, service class tag, volume and time stamp is sent to GGSN in a new GTP message, 3, substantially immediately at occurrence of the loss.

If on the other hand BSC discards traffic, BSC includes the relevant info, here service class tag, volume, time stamp in a BSSGP LLC Discarded message towards SGSN, 3′.

To enable real-time compensation in the GGSN, a new GTP message, e.g. GTP discarded traffic report with IMSI, NSAPl, service class tag, volume and time stamp (here) is sent to GGSN, 4′, substantially as soon as SGSN detects or is informed of the loss.

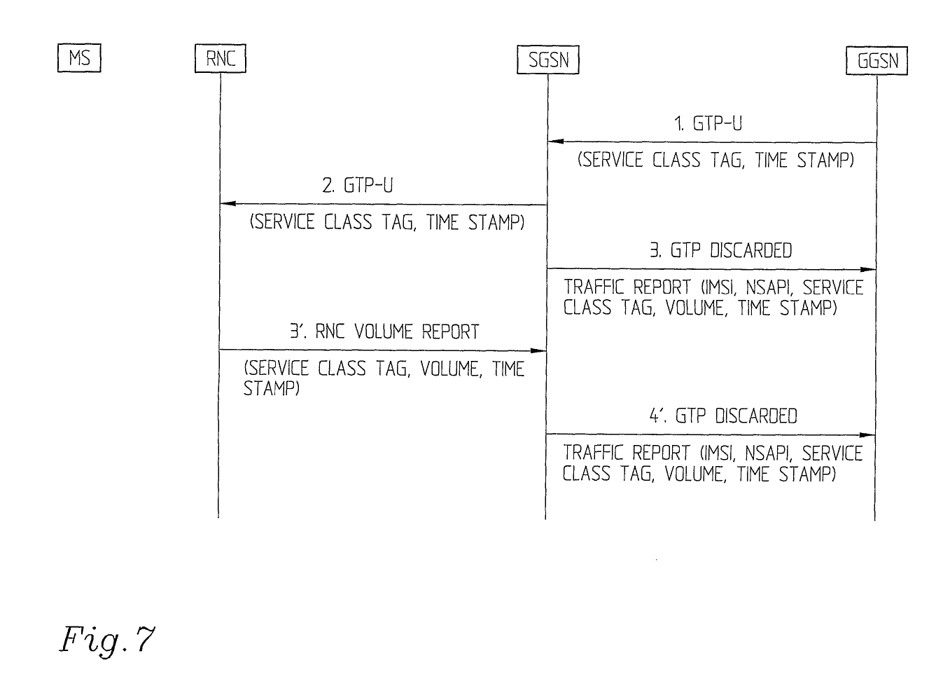

In the signalling diagram of FIG. 7 it is supposed that the SGSN access node only supports RNC communication. In the other aspects the same principles as in the embodiment of FIG. 6 apply. Thus, here the service class tag and the time stamp is simply forwarded, 2, by SGSN to RNC since also between SGSN and RNC the GTP protocol is used (GTP-U, userplane). If RNC discards traffic, RNC sends a volume report with service class tag, volume and time stamp to SGSN, 3′. The signalling denoted 1, 3, 4′ in FIG. 7 corresponds to the signalling with the corresponding references in FIG. 6.

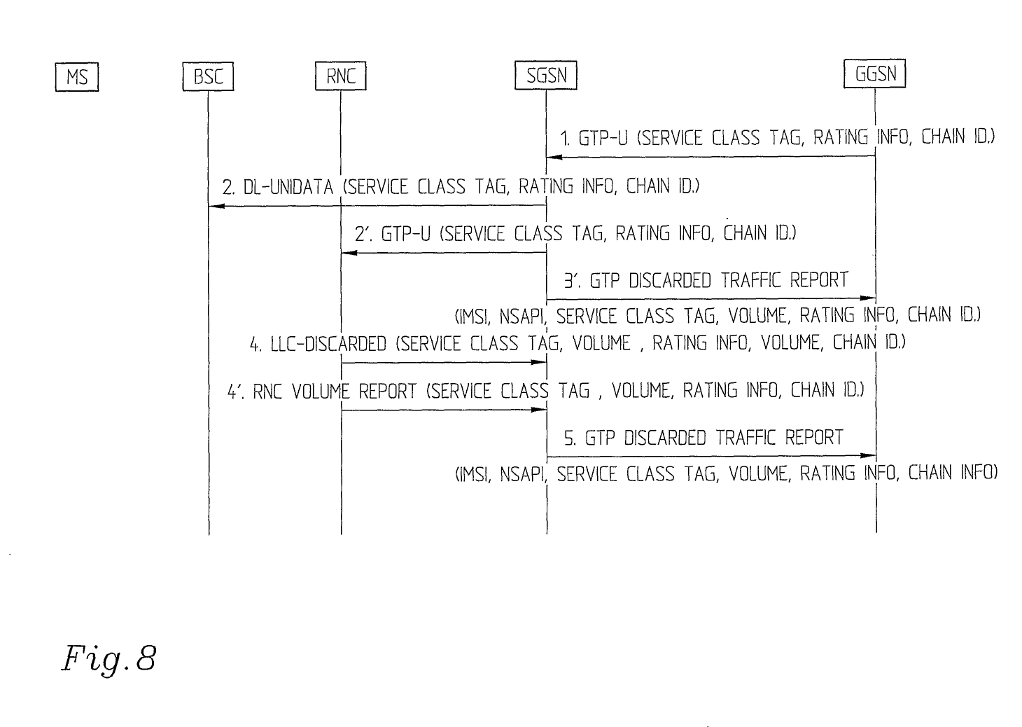

FIG. 8 is a signalling diagram relevant for another implementation supporting real-time compensation for lost packets. It is here supposed that SGSN is a dual access node, but an implementation as in FIG. 8 of course also is possible if SGSN only supports BSC or RNC, in which cases the corresponding signalling to/from the node not supported should be deleted from FIG. 8. Like in FIGS. 6, 7 it is supposed that a flexible charging functionality is supported by GGSN. The difference from FIGS. 6, 7 is that the information provided to SGSN, BSC and/or RNC contains service class tag, rating info and chain id and that the loss reports contain IMSI, NSAPI, service class tag, volume, rating info and chain id.

If flexible charging is supported by SGSN or if SGSN and GGSN are combined into a CGSN, the messageing between SGSN-GGSN is of course superfluous.

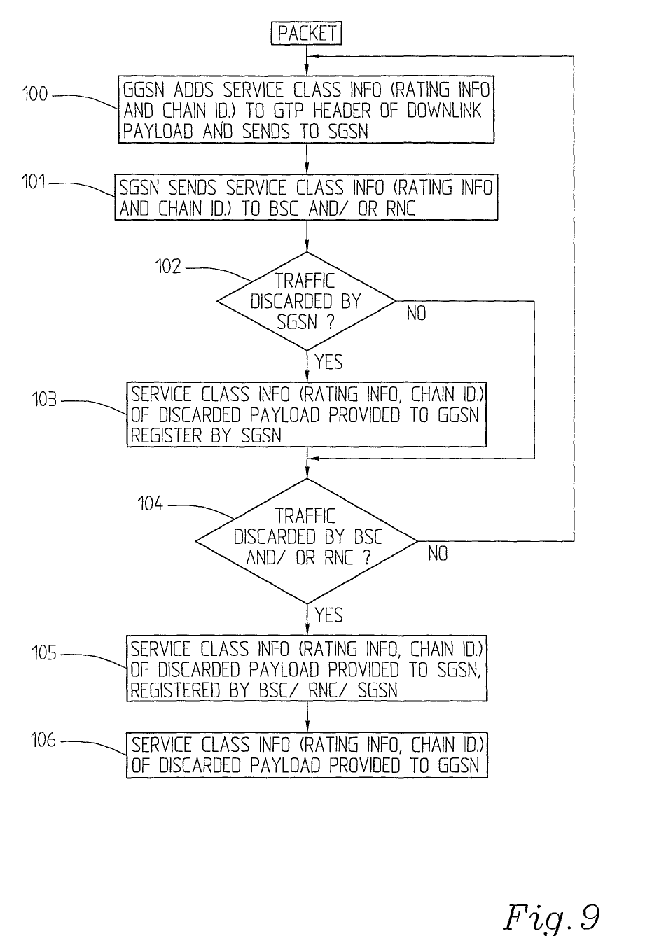

FIG. 9 illustrates, in the form of a flow diagram, the procedure when GGSN supports flexible/content based charging. GGSN here adds service class info (and preferably rating info and chain id) to the GTP header of the downlink (DL) payload, and sends to SGSN, 100. SGSN sends service class info (rating info, chain id) to BSC and/or RNC, 101. If/when traffic is discarded by SGSN, 102 yes, service class info (rating info, chain id) of the discarded payload is provided to GGSN and registered by SGSN, 103 (for a real time implementation). If (when) traffic is discarded by BSC/RNC, 104 yes, service class info (rating info, chain id) of the discarded payload is provided to SGSN and registered by BSC/RNC/SGSN, 105. Subsequently, for real time compensation, service class info (rating info, chain id) of discarded payload is provided from SGSN to GGSN, 106.

For real time implementations loss reports to SGSN/GGSN are provided substantially immediately upon occurrence to GGSN, including e.g. IMSI, NSAPI as discussed above.

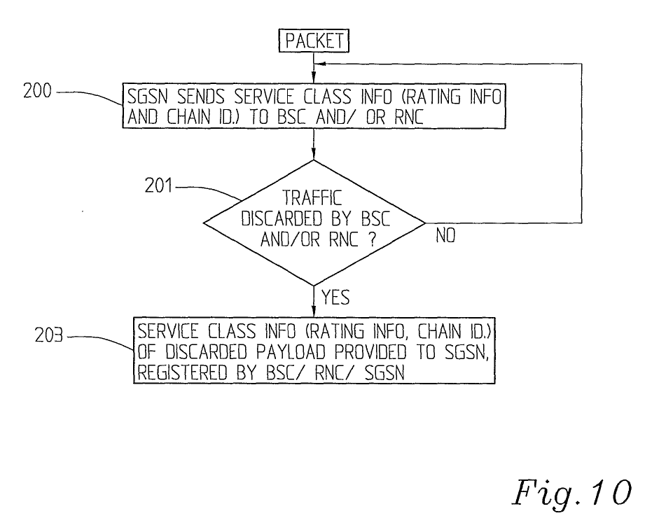

FIG. 10 is a flow diagram describing a procedure as in FIG. 9, but wherein the flexible/content based charging functionality is supported by SGSN. As can be seen only steps 101, 104 and 105 remain, here denoted 200, 201, 202. As can be seen, the procedure is considerably facilitated.

The functioning will be substantially the same if a CGSN node is used.

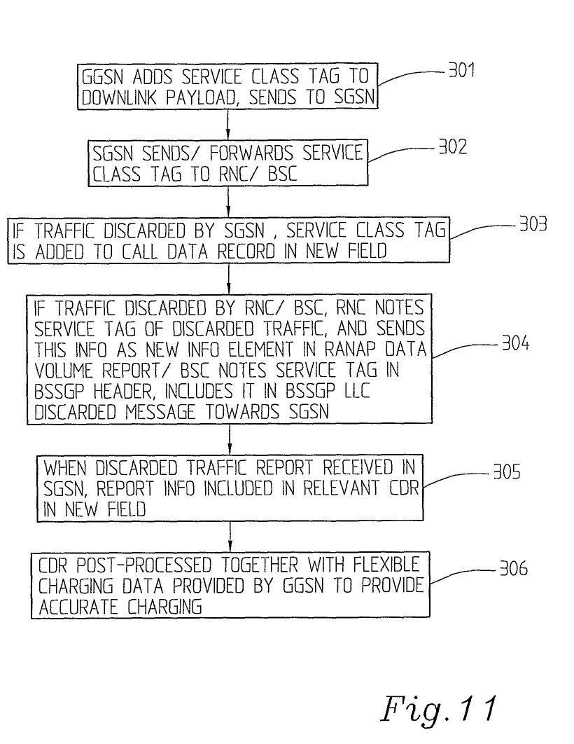

FIG. 11 is a flow diagram describing an implementation of the inventive concept when CDR based charging (not in real time) is implemented. As discussed above, GGSN adds a service class tag to the downlink payload sent to SGSN, 301. SGSN sends/forwards the service class tag to RNC/BSC, 302. If traffic is discarded by SGSN, the service class tag is added to the appropriate Call Data Record (CDR) in a new field, 303, and compensation for lost traffic is performed e.g. by the operator using information as to type etc provided by GGSN when the CDR is handled, e.g. at night.

If traffic is discarded by RNC, RNC notes the service tag of the discarded traffic and sends this info as a new information element in a RANAP Data Volume Report. If traffic is discarded by BSC, BSC notes the service tag in the BSSGP header, includes it in a BSSGP LLC Discarded message towards SGSN, 304.

When such a discarded traffic report is received in SGSN, the report info is included in the appropriate CDR in a new field, cf. step 303 above. After step 303 and/or 305, the CDR is post-processed together with the flexible charging data info provided to SGSN by GGSN to provide for accurate charging with lost traffic compensation, 306.

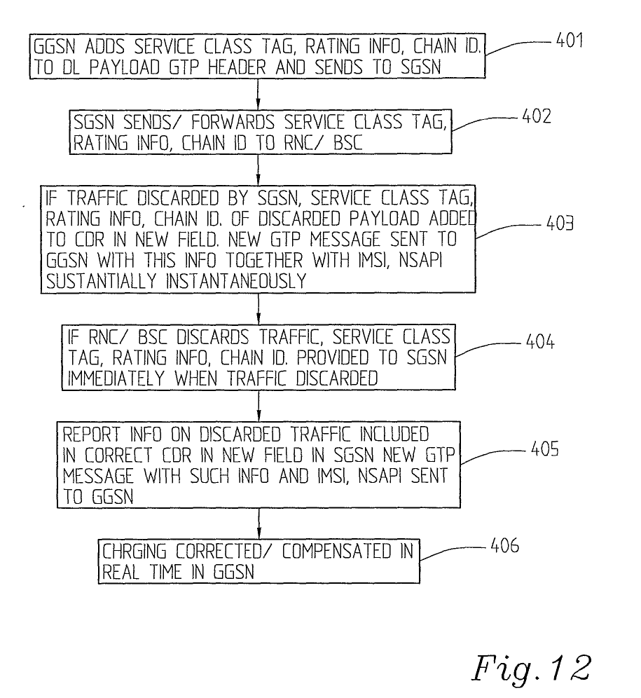

FIG. 12 illustrates a procedure allowing for charging compensation for lost packets in real time. In the shown embodiment GGSN adds service class tag, rating info, chain id to the DL payload GTP header sent to SGSN, 401. SGSN in turn sends/forwards service class tag rating info, chain id to RNC and/or BSC, 402.

If traffic is discarded by SGSN, service class tag, rating info, chain id of the discarded payload may be added to the appropriate CDR in a new field, and a new GTP message is sent to GGSN with this information together with IMSI, NSAPI substantially instantaneously, 403. If RNC and/or BSC discards traffic, service class tag, rating info, chain id are provided to SGSN immediately upon traffic discarding, 404. Report information about the discarded traffic may then be included in the correct CDR in a new field in SGSN. A new GTP message with such info and IMSI, NSAPI is then sent to GGSN, 405. (cf. step 403). Charging is then corrected/compensated for lost traffic in real time in GGSN, 406.

FIG. 13 shows the signalling format used between GGSN-SGSN and SGSN-RNC which use the GTP protocol. The information (e.g. service tag, rating info and chain id), is introduced in the GTP header.

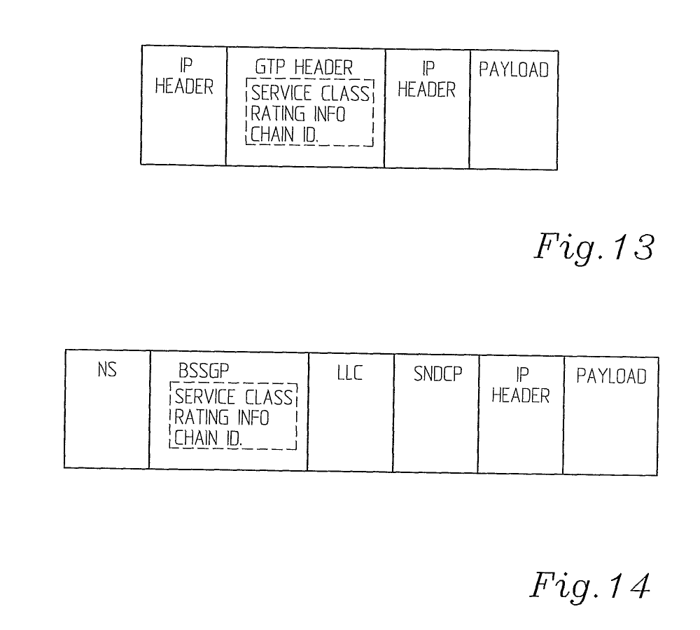

FIG. 14 shows the format used between SGSN and BSC. The relevant information is here introduced into BSSGP. The format is known as such, NS, Network service, LLC, SNDCP Sub Network Dependent Convergence Protocol.

According to the invention it gets possible to compensate flexible charging for downlink payload discarded by e.g. BSC, RNC, SGSN or a node with a similar functionality.

It should be clear that the invention is not limited to the specifically illustrated embodiments, but that it can be varied in a number of ways within the scope of the appended claims.

It should also be clear that other nodes in other communication systems having similar functionalities as e.g. GGSN, SGSN, CGSN, BSC also are covered by the inventive concept.

1. An arrangement, for allowing compensation of lost, discarded or unsent traffic on the downlink in a communication system supporting communication of packet data and classification of mobile traffic allowing application of different charging schemes for different types of traffic, comprising
a packet data node handling classification of traffic into different types, including service class, and for applying an appropriate charging scheme depending on type, that said node provides and sends information relating to type, including service class, to subsequent nodes on the downlink to a mobile station, wherein a subsequent node detecting a packet loss, notes said loss and enables use of the information of said loss together with type information to enable for correction of charging due to traffic loss.

2. The arrangement according to claim 1, wherein
radio nodes provide correction/compensation for lost traffic at predetermined intervals loss reports are provided to a preceding packet data node, said loss reports including at least said type information for said discarded/lost data traffic and
said packet data nodes includes said type information in a new field in a Call Detail Record or similar.

3. The arrangement according to claim 1, wherein charging correction/compensation for lost traffic is performed in real time and loss reports are provided from radio nodes to a preceding packet data node at occurrence of the loss, and in that a loss report including type information is provided to the packet data node supporting flexible charging together with subscriber information and access point identification in a new message, e. g. a new GTP-message.

4. The arrangement according to claim 1, wherein the packet data node comprises a packet data node with a gateway functionality.

5. The arrangement according to claim 1, wherein that the packet data node comprises a serving packet data node.

6. The arrangement according to claim 1, wherein the packet data node comprises a packet data serving functionality and a gateway functionality.

7. The arrangement according to claim 1, wherein said packet data node handling classification and labeling provides traffic packets with service class information and rating information.

8. The arrangement according to claim 1, wherein said packet data node handling classification and labeling provides traffic packets service class information and a time stamp.

9. The arrangement according to claim 7, wherein the traffic packets are provided with chain identification information.

10. The arrangement according to claim 1, wherein the packet data node is an access node in a GSM/GPRS system in communication with BSC:s.

11. The arrangement according to claim 1, wherein the packet data is an access node supporting a UMTS/GPRS system and supports communication with RNC:s.

12. The arrangement according to claim 10, wherein the packet data node is a dual access node supporting communication with BSC's and RNC's.

13. The arrangement according to claim 2, wherein loss reports relating to discarded traffic are sent periodically and at given times.

14. The arrangement according to claim 2, wherein loss reports relating to discarded traffic are sent based on the volume of given types of the discarded traffic or service classes.

15. The arrangement according to claim 3, wherein loss reports relating to discarded traffic are provided/sent in real time, substantially instantly at the occurrence of a loss directly or indirectly to the node handling flexible charging.

16. The arrangement according to claim 1, wherein the classification and charging scheme application handling is performed by a gateway packet data node and in that it supports a content based charging functionality.

17. The arrangement according to claim 16, wherein
information relating to type is provided to a packet data node with a serving functionality, and said node forwards such information to subsequent nodes, and if a different protocol is used than the protocol used between the serving node and the gateway packet data node, a conversion is performed such that the information can be sent over said different protocol.

18. The arrangement according to claim 17, wherein the serving packet data node is a SGSN, the gateway packet data node is a GGSN and in that the information relating to at least type is added to the GTP header of the downlink payload to SGSN, if relevant to RNC's, whereas if it is to be forwarded to BSC's, the information is included in the BSSGP header.

19. The arrangement according to claim 3, wherein an RNC having discarded traffic, a loss report comprising a RANAP Data Volume Report is sent at occurrence of the loss of data to the preceding packet data node uplinks and unless such preceding node handles flexible charging, it sends the new loss report message with IMSI, NASAPI to the node handling such functionality.

20. The arrangement according to claim 3 wherein for a BSC having discarded traffic, a loss report including at least service class information, rating information or a time stamp, is sent to the preceding packet data node uplinks at occurrence of the loss for charging correction/compensation, wherein said packet data node, unless the packet data node handles the flexible charging functionality, provides the new loss report message with IMSI, NSAPI to the node handling such functionality.

21. The arrangement according to claim 1, wherein the subsequent nodes register at least type and amount of information about discarded packets.

22. A packet data node in a communications system supporting communication of packet data handling classification and application of charging depending on type of, or characteristic of, traffic comprising:
means for sending information about type at least type, e. g. service class, of data packets sent on the downlink to subsequent nodes and that such subsequent nodes send reports relating to discarded/lost traffic packets, with type information, to said packet data node allowing said packet data node to modify charging to compensate for lost data packets, unless said packet data node itself supports the flexible charging functionality.

23. The packet data node according to claim 22, further comprising a serving packet data support node (SGSN), a gateway packet data support node (GGSN) or a combined gateway and serving packet data support node (CGSN).

24. The packet data support node according to claim 22, further comprises means for forwarding service class information (QoS), rating information or time stamp information for sent packets and optionally for chain information (chain id) to subsequent nodes.

25. The packet data support node according to claim 22, further comprises means for supporting real time compensation/correction for lost packets, wherein loss reports are provided in real time.

26. A method for allowing charging correction or compensation for lost discarded or unsent data packets on the downlink towards a mobile station in a system supporting content based charging or flexible bearer charging, comprising the steps of:
sending information relating to assigned charging scheme to subsequent nodes (SGSN; RNC; BSC) from a node handling classification of packets and content based charging;
sending a report, from one such subsequent node towards the node handling classification and application of content based charging, from a node discarding an IP packet if said node does not support content based charging.

27. The method according to claim 26, wherein the step of sending information comprises
sending service class, rating information or providing a time stamp for a packet and, optionally, information for identifying the chain an IP packet belongs to.

28. The method according to claim 26, wherein the reporting step comprises:
sending a report including subscriber id (IMSI), access point id (NSAPI) from a node, upon detecting that a packet is discarded, to allow for real time compensation/correction, wherein such node further
registers discarded packet type and amount of discarded packets.

29. The method according to claim 26, wherein the reporting step comprises:
introducing the reporting information in a packet sent over the relevant protocol between nodes up to the node handling classification/content based charging.

30. The method according to claim 26, wherein the node handling classification/charging comprises one of a gateway packet data node (GGSN), a serving packet data node (SGSN) or a combined gateway and serving packet data node (CGSN).

31. The method according to claim 26, wherein reporting is performed based on volume, with given time intervals or at given points in time.
